(19) United States
(12) Patent Application Publication
(10) Pub. No.: US 2022/0201938 A1
(43) Pub. Date: Jun. 30, 2022

(54) RANDOMIZED EPC GENERATION FOR BALE IDENTIFICATION TAG

(71) Applicant: AGCO Corporation, Duluth, GA (US)

(72) Inventors: Kevin J. Hamilton, Newton, KS (US); Emmanuel Regis Magisson, Hesston, KS (US); Daniel J. Soldan, Hillsboro, KS (US); Grant Lewis Good, Moundridge, KS (US); Robert L. Figger, Hesston, KS (US); Shane A. Bollinger, Hesston, KS (US)

(21) Appl. No.: 17/645,962

(22) Filed: Dec. 23, 2021

Related U.S. Application Data
(60) Provisional application No. 63/132,435, filed on Dec. 30, 2020.

(51) Int. Cl. A01F 15/08; A01F 15/04; A01F 15/07; A01F 15/14; G06K 19/077; G06K 19/07

(52) U.S. Cl. CPC A01F 15/0825; A01F 15/042; A01F 15/071; A01F 2015/076; G06K 19/07758; G06K 19/0723; A01F 15/145

(57) ABSTRACT

A method for assigning information to an identification tag on a bale includes receiving, compressing and shaping crop material into a plurality of formed bales. At least one sensor parameter for the formed bales is detected with at least one sensor. Each bale is wrapped with a binding material and an identification tag is attached to each of the formed bales. A bale ID is created for each of the formed bales. The identification tag on the bale for each bale is assigned to the bale ID. The operator selects to have either the sensor parameter for the tagged bale associated with the bale ID or have a semi-randomized code not containing the sensor parameter associated with the bale ID.

### CROSS REFERENCE TO RELATED APPLICATION

This application claims the benefit of U.S. Provisional Application No. 63/132,435, filed Dec. 30, 2020, which is hereby incorporated by reference in its entirety.

### BACKGROUND OF THE INVENTION

### Field of Invention

The present disclosure is generally related to agricultural balers and, more particularly to a method and assembly for supplying bale identification tags to bales of agricultural crop material.

### Description of Related Art

Large square balers are used in the agricultural industry to create large substantially rectangular bales of crop material by moving over crop windrows to collect loose crop material, compress it, and form it into bales that are then bound and ejected. To that end, a baler is typically mechanically coupled with a tractor, and a power take-off (PTO) mechanism transfers power from the tractor's engine to drive the baler's operation. A rotary pick-up at the front of the baler collects the loose crop material and moves it into a feeder chute. Once the feeder chute is full, its contents are moved into a forming chamber. A reciprocating plunger compresses the crop material in the forming chamber into a growing bale. Once the bale reaches a predetermined length, which could be eight feet, it is tied and ejected through a discharge outlet to fall onto the ground behind the baler. The process then continues to create the next bale.

The ability to trace or track parameters of each bale may be useful to an end user. Baled products, such as hay or silage, may be fed to livestock, and the quality of the feed may be important to the diet of the livestock. For example, a higher quality feed may be fed to certain livestock, whereas feed with lesser quality may go to a different type of livestock. It may be desirable to trace where food products come from, what the livestock ate while it was being raised, etc. It is also desirable to be able to label each bale with other important properties, such as moisture content and nutritional value. Other potential parameters of interest include but are not limited to GPS Location when bale is tied, where the bale leaves the baler, farm name, farmer id, field name, preservative type, amount of preservative applied, etc. As a result, bale identification systems may be employed in the baling process for storing or otherwise retaining the parameters or quality of the crop so it can be provided to the end user.

To identify a bale, it is known to attach a tag containing information such as the size, weight, and date of the bale. However, it has been found to be desirable at desired times not include data concerning feed value, moisture, flake count, etc., so as to not publicize such data or make it available to competitors.

### BRIEF SUMMARY OF THE INVENTION

Briefly stated, one aspect of the invention is directed to a method for assigning information to an identification tag on a bale. The method includes receiving, compressing and shaping crop material into a plurality of formed bales. At least one sensor parameter for the formed bales is detected with at least one sensor. Each bale is wrapped with a binding material and an identification tag is attached to each of the formed bales. A bale ID is created for each of the formed bales. The identification tag on the bale for each bale is assigned to the bale ID. The operator selects to have either the sensor parameter for the tagged bale associated with the bale ID or have a semi-randomized code not containing the sensor parameter associated with the bale ID.

This summary is provided to introduce concepts in simplified form that are further described below in the Description of Preferred Embodiments. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiment.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic diagram of an baler; and

FIG. 2 is a flowchart of a method of grouping bales into a transportation group and determining the weight of the transportation group.

Corresponding reference characters indicate corresponding parts throughout the views of the drawings.

### DESCRIPTION OF PREFERRED EMBODIMENTS

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

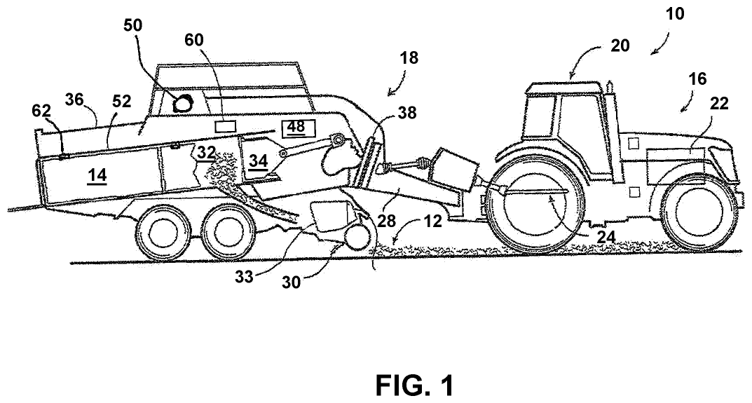

Referring now to FIG. 1, shown is a semi-schematic diagram of an agricultural baler system 10 which may be employed while baling loose crop material 12 from the ground into bales 14. The baler system 10 includes a towing vehicle 16 and a baler 18. The baler 18 is hitched to the towing vehicle 16 by a fore-and-aft tongue 28, and power for operating the various mechanisms of the baler 18 may be supplied by the PTO 24 of the towing vehicle 16, though not limited as such. One having ordinary skill in the art should appreciate in the context of the present disclosure that the example baler 18 is merely illustrative, and that other types of baling devices that utilize bale identification assemblies may be implemented.

The baler 18 has a fore-and-aft extending baling chamber denoted generally by the numeral 32 within which bales 14 of crop material 12 are prepared. A pickup assembly broadly denoted by the numeral 30 is positioned under the tongue 28 on the longitudinal axis of the machine, somewhat forwardly of the baling chamber 32. A stuffer chute assembly 33 is generally shown, and includes a charge forming stuffer chamber that in one embodiment is curvilinear in shape. In the particular illustrated embodiment, the baler 18 is an “extrusion” type baler in which the bale discharge orifice at the rear of the baler is generally smaller than upstream portions of the chamber such that the orifice restricts the freedom of movement of a previous charge and provides back pressure against which a reciprocating plunger 34 within the baling chamber 32 can act to compress charges of crop materials into the next bale as would be understood by one skilled in the art.

The plunger 34, as is known, reciprocates within the baling chamber 32 in compression and retraction strokes across the opening at the bottom of the baling chamber 32. The reciprocating plunger 34 presses newly introduced charges of crop material against a previously formed and tied bale 14 to thereby form a new bale. This action also causes both bales to intermittently advance toward a rear discharge opening 14 of the baler. The completed bales 14 are tied with binding material or a similar twine. Once tied, the bales are discharged from the rear end of the bale-forming chamber 32 onto a discharge in the form of a chute, generally designated 36.

The baler 18 may include one or more computing devices such as electronic control unit (ECU) 48. It will be understood that one or more ECUs 48 may be employed and that ECU 48 may be mounted at various locations on the towing vehicle 16, baler 18, or elsewhere. ECU 48 may be a hardware, software, or hardware and software computing device, and may be configured to execute various computational and control functionality with respect to baler 18 (or towing vehicle 16). As such, ECU 48 may be in electronic or other communication with various components and devices of baler 18 (or towing vehicle 16). For example, the ECU 48 may be in electronic communication with various actuators, sensors, and other devices within (or outside of) baler 18. ECU 48 may communicate with various other components (including other controllers) in various known ways, including wirelessly.

As the baled crop material 12 is formed in the baler 18, certain parameters or qualities of the crop material 12 or bale 14 such as moisture quality, baling time, bale weight, bale length, etc. may be measured or determined by the baler 18. One skilled in the art will understand how these crop or bale parameters may be measured using known sensors and techniques so further discussion of such sensors or measurement techniques need not be contained herein. Each measurement may be communicated to the ECU 48 for recording. The ECU 48 may communicate the detected measurement to a data server or other database for storage. The measurements may be stored locally via the data server or wirelessly communicated via a mobile device to a remote location over the cloud-based technology.

A knotter system 50 is configured to loop a binding material 52 around the finished bale 14. The term “binding material” as used herein is intended to mean not only twine made from natural or synthetic fibers, but may also include metallic wire or other strapping material. As knotter systems 50 are well known in the art, further description of the knotter system need not be included herein.

A bale identification assembly 60 is provided for assigning attributes of the crop material 12 and/or bale 14 to a bale identification tag 62 applied to the bale 14. Desirably, the bale identification tag 62 is a passive radio-frequency identification (RFID) tag used to electronically store information and collect energy from a nearby RFID reader's interrogating radio waves. As RFID tags are known to those skilled in the art, a detailed description of the RFID tag need not be provided herein. In embodiments of the present invention, the binding material 52 applied by the knotter system 50 is provided with bale identification tags 62. Bale identification tags 62 may be placed in the binding material 52 at certain intervals.

In one embodiment, instead of storing bale attribute data directly to the bale identification tag 62, a bale ID for a given bale 14 is assigned to the identification tag 62 and attributes of that bale 14 such as weight, variety, location, moisture, feed value, mass flow, flake count, time of day, etc., are associated with the bale ID, which is then assigned to the identification tag 62 using software and a task controller post bale drop. The attributes and the bale tag identification number may be stored in a data server or database in an organized format such as an Electronic Product Code (EPC) so that it may be retrieved at a later time. For example, a user of a mobile device may access the data wirelessly via Wi-Fi, cloud-based technology or any other known communication means by accessing a server or database where the information is stored. In this manner, the data associated with any bale 14 may be tracked from a remote location at any given time. In one embodiment the bale identification assembly 52 and identification tags 62 are as described in commonly assigned U.S. Pat. No. 10,303,997 entitled Bale Identification Assembly for Binding and Identification Tag to a Bale of Agricultural Crop Material, which is incorporated herein by reference. However, one skilled in the art will understand that other bale identification tags and methods of associating bale attributes with the bale tag for a given bale may be used without departing from the scope of the invention.

As EPC codes for the bales 14 are associated with the identification tags 62, it has been found to be desirable to the customer to at desired times not include data concerning feed value, moisture, flake count, etc., so as to not publicize such data or make it available to competitors. For the sake of simplicity and data management it is also desirable to have a single identifying number rather than a bale ID assigned by a task controller and a purely randomized EPC both recorded. According to the invention, the operator may select have the ECU 48 generate a semi randomized EPC code. This EPC code would then by written to the identification tag 62 for its corresponding bale 14 during the baling process. Desirably, this EPC code would not contain specific information about bale attributes but instead would contain data such as a portion of the serial number of the baler 18, the serial number of the ECU 48 or EPC reader, and the total bale count for those particular serial numbers. This would provide a single unique identifier that would not disclosing any potentially sensitive data.

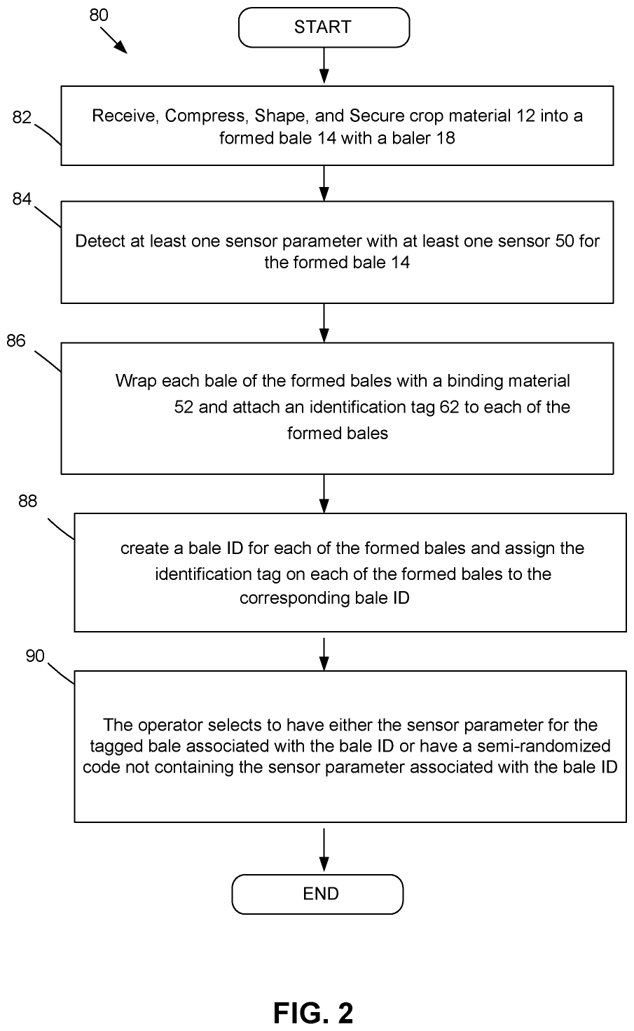

Referring also to FIG. 2, an embodiment of a method 80 is shown for determining the. The method 80 may comprise some or all of the following steps, which may be implemented by components of the baler system 10 described above. As discussed, crop material 12 may be received and shaped and secured by a baler 18 into a plurality of bales 14, as shown in step 82. Detect at least one sensor parameter with at least one sensor 50 for the formed bale 14 as shown in step 84. Bind the formed bale with the binding material such that an identification tag 62 is applied to obtain a tagged bale 14 as shown in step 86. As shown in step 88, the identification tag 62 on the bale is assigned to a corresponding bale ID. As shown in step 90, the operator selects to have either the sensor parameter for the tagged bale associated with the bale ID or have a semi-randomized code not containing the sensor parameter associated with the bale ID.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A method for assigning information to an identification tag on a bale comprising:
receive, compress and shape crop material 12 into a plurality of formed bales 14;
detect at least one sensor parameter with at least one sensor 50 for the formed bales;
wrap each bale of the formed bales with a binding material 52 and attach an identification tag 62 to each of the formed bales;
create a bale ID for each of the formed bales;
assign the identification tag 62 on each of the formed bales to the corresponding bale ID; and
select to have either the sensor parameter for the formed bale associated with the bale ID or have a semi-randomized code not containing the sensor parameter associated with the bale ID.
